(19) United States
(12) Patent Application Publication
(10) Pub. No.: US 2014/0041793 A1
(43) Pub. Date: Feb. 13, 2014

(54) CASTING MATERIAL AND METHODS OF USE

(71) Applicants: Kit J. Morrison, Bountiful, UT (US); Matthew Hawkes, West Jordan, UT (US)

(72) Inventors: Kit J. Morrison, Bountiful, UT (US); Matthew Hawkes, West Jordan, UT (US)

(73) Assignee: FIBER FIX INTERNATIONAL, LLC., Bountiful, UT (US)

(21) Appl. No.: 13/611,358

(22) Filed: Sep. 12, 2012

Related U.S. Application Data
(60) Provisional application No. 61/573,933, filed on Sep. 15, 2011.

(51) Int. Cl. B29C 65/00

(52) U.S. Cl. CPC B29C 65/00
USPC 156/191; 156/475

(57) ABSTRACT

In one example, an attachment method includes positioning first and second inanimate elements proximate each other, and then wrapping a fabric about portions of the first and second inanimate elements so as to at least partly connect the first and second inanimate elements to each other. The fabric may be impregnated with a casting material. The casting material is then cured.

### RELATED APPLICATIONS

This application hereby claims priority to U.S. Provisional Patent Application Ser. 61/573,933, entitled FIBER-FIX MATERIAL, filed Sep. 15, 2011, and incorporated herein in its entirety by this reference.

### BACKGROUND

1. Field of the Present Disclosure

The present disclosure is generally concerned with casting materials and methods and applications associated with the same. More specifically, at least some embodiments concern various types of fabrics and similar materials that may be impregnated with liquid materials that can harden under certain environmental conditions. In one particular example, a fabric is provided that may be impregnated with a resin. The impregnated fabric may be used to effect the repair of an item, which may be relatively rigid or relatively flexible, by disposing the impregnated fabric in a desired position relative to the item, and then permitting the resin to harden.

2. Description of Related Art

When faced with the problem of a broken item, such as the handle of a gardening tool for example, a user generally has the choice of attempting to repair the item, or discarding the item and purchasing a replacement. Neither approach is particularly satisfactory.

For example, if the user should choose to replace the item, the user will incur not only the expense of the item, and possibly other expenses, such as shipping and taxes for example. In terms of intangibles, the user must spend time to locate and purchase the item, when that time might be profitably employed in other pursuits. In other instances, where the item may be relatively uncommon, it may be difficult or impossible to find a suitable replacement. In such an instance, the user may have to strike a compromise and attempt to find a substitute that may or may not be fully satisfactory for its intended use.

Rather than attempting to find a replacement for the broken item, the user may attempt to repair the item, and thereby avoid some of the difficulties noted above. However, depending upon the item to be repaired and the type of damage, some breaks or other damage may not lend themselves to a wide range of remedies. Thus, a user may attempt to effect a repair of a broken item with materials such as duct tape or electrician's tape. However, such materials can deteriorate relatively quickly due to exposure to conditions such as moisture, sunlight, and abrasion. Moreover, where repair of a relatively rigid item, such as a tool handle for example, is desired, flexible materials such as the aforementioned tapes may not provide for a particularly effective repair.

### BRIEF SUMMARY OF ASPECTS OF EXAMPLE EMBODIMENTS

It should be noted that the embodiments disclosed herein do not constitute an exhaustive summary of all possible embodiments, nor does this brief summary constitute an exhaustive list of all aspects of any particular embodiment(s). Rather, this brief summary simply presents selected aspects of some example embodiments. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should such embodiments be construed to implement, or be limited to implementation of, any particular technical effect(s) or solution(s).

Disclosed embodiments are generally concerned with casting materials and methods and applications associated with the same. Embodiments within the scope of this disclosure may include any one or more of the following elements, in any combination: fabric; porous fabric; fiberglass fabric; fabric in the form of tape; fabric in the form of rolled tape; fibrous material; resin; synthetic resin; natural resin; non-resin casting material; biodegradable casting material; biodegradable resin; biodegradable fabric; casting material with one or more additives; rubber, plastic, and/or fibrous material additives; resin with one or more additives; a casting material that includes rubber and/or plastic additives; a casting material that includes a fibrous material additive; a casting material that includes a polyester fibrous material additive; casting material with a biodegradable additive; casting materials that may be hardened by exposure to one or more curing agents; casting materials that may be hardened by exposure to one or more of light, water, heat, and air; resin that may be hardened by exposure to one or more of light, water, heat, and air; colored casting material; colored resin; combinations of two or more types of casting materials; combinations of two or more types of resins; fabric impregnated with a casting material; fabric impregnated with a resin; fiberglass fabric impregnated with a casting material; fiberglass fabric impregnated with a resin; non-biodegradable casting materials; non-biodegradable casting materials; substantially waterproof casting materials; substantially waterproof fabrics; ultraviolet (UV) resistant casting materials; UV resistant fabrics; fire-resistant casting materials; fire-resistant fabrics; fabrics including one or more natural materials; synthetic fabrics; casting materials that cure to a substantially rigid state; casting materials that cure to a partially flexible state; a kit including any one or more of the aforementioned fabrics and/or casting materials; an item having a repair that includes any one or more of the aforementioned casting materials and/or fabrics; and, an item having a repair that includes any one or more of the aforementioned casting materials and/or fabrics, wherein the item is a plant or inanimate object.

### BRIEF DESCRIPTION OF THE DRAWINGS

The appended drawings contain figures of some example embodiments to further explain various aspects of the present disclosure. It will be appreciated that these drawings depict only some embodiments of the disclosure and are not intended to limit its scope in any way. The disclosure will be described and explained with additional specificity and detail through the use of the accompanying drawings in which:

FIG. 1 is a flow diagram disclosing aspects of a method for joining two items, or repairing an item with two pieces at least partly separated from each other;

FIG. 2a discloses an item with two pieces at least partly broken apart from each other;

FIG. 2b discloses an item with a hole or other opening;

FIG. 3 discloses an example implementation where a fabric impregnated with a casting material takes the form of a roll, and an item is partially wrapped with the fabric;

FIG. 4 discloses an item having two elements joined together with a shell formed by fabric impregnated with a casting material; and

FIG. 5 discloses an item with a shell that has been further processed.

### DETAILED DESCRIPTION OF SOME EXAMPLE EMBODIMENTS

The present disclosure is generally concerned with casting materials and methods and applications associated with the same. More specifically, at least some embodiments concern various types of fabrics and similar materials that may be impregnated with liquid materials that can harden under certain environmental conditions.

A. General Aspects of Some Example Embodiments

In general, embodiments of the invention may include a fabric that may be impregnated with, or otherwise treated with or include, a casting material such as resin for example. The resin-bearing fabric may be used in the repair of an item that has been broken, or in the attachment of one element to another, and the resin itself may be curable such that upon exposure of the resin to a curing agent such as light, heat, water and/or air for example, the resin will harden.

The casting material and fabric may or may not be included together as part of a kit. In one particular example, a kit may include a roll of resin impregnated fabric. Such kits may be sealed or otherwise packaged to minimize or eliminate premature exposure of the casting material to curing agents, such as air and/or water. In some instances, a kit may also include gloves for the user to use when handling the casting material.

B. Example Applications of Embodiments of the Invention

As will be apparent from the disclosure herein, the casting materials and fabrics disclosed may be employed in a wide variety of applications. For the purposes of illustration, and not limitation, some general categories of uses for the casting materials and fabrics will now be discussed. In some instances, the casting materials and fabrics may be used to repair, temporarily or permanently, broken items. In other instances, the casting materials and fabrics may be used to join two or more elements together, even if the elements were not previously broken apart from each other. In still other cases, the casting materials and fabrics may be used to patch holes.

While it would be impractical to list all the possible applications of the casting materials and fabrics disclosed herein, the following examples serve to illustrate the broad range of possible applications. In general, the casting materials and fabrics disclosed herein may be employed to effect repairs of broken items that may be rigid, or relatively flexible. As used herein, the term ‘repair’ is intended to be broadly construed and includes, but is not limited to: the joining of two pieces of an item that have partially or completely broken apart from each other; and, the covering of a hole in an item.

General areas of application include, but are not limited to, industry, home and garden, sporting goods, recreation, landscaping, and agriculture. To list some more specific and non-limiting examples, the casting materials and fabrics may be used to repair, temporarily or permanently, items such as garden tool handles, ski poles, hiking poles, golf clubs, baseball and softball bats, fishing rods, piping, tubing, sprinkler piping, tent poles, hoses, carbon bike frame tubes, oars, paddles, posts, rails, luggage racks, and furniture. In addition to use in the repair, or joining, of elements of the aforementioned inanimate objects, various specialized applications of the casting materials and fabrics are also possible.

For example, the casting materials and fabrics may also be employed in connection with living matter, such as a limb of a human or animal for example. In one particular example, the casting materials and fabrics may be employed as part of a first aid kit and used, for example, to mobilize a person's broken limb or other bone until medical help can be obtained. In another example, the casting materials and fabrics may be employed in connection with living matter, such as to graft tree limbs, and to repair tree limbs that have been damaged or broken. In this example application, the casting material may take the form of a biodegradable resin that is compatible with the tree limbs. The resin may have a green color, or earth tone color, to better blend with the natural colors of the tree or other plant.

C. Example Materials with which Embodiments May be Employed

As should be evident from the preceding discussion, the casting materials and fabrics disclosed herein may be used in connection with a variety of different materials. Such materials include, but are not limited to, wood, metal, glass, plastic, rubber, composites, fiberglass, ceramic, concrete, and combinations of any of the foregoing.

D. Example Casting Materials and Fabrics

The scope of the invention is not limited to any particular casting material or fabric, or combination of casting material(s) and fabric(s). Rather, a wide variety of casting materials and fabrics, and combinations thereof, may be employed. In general, one or more casting materials may be used in conjunction with a single fabric, or combination of fabrics. As used herein, ‘casting material’ is intended to be construed broadly and embraces, but is not limited to, any and all of the casting materials disclosed herein. As used herein, ‘fabric’ is intended to be construed broadly and embraces, but is not limited to, any and all of the fabrics disclosed herein.

Examples of casting materials that may be employed include, but are not limited to, biodegradable casting materials, non-biodegradable casting materials, synthetic resins, natural resins, casting materials that include one or more additives, resins that include one or more additives. Examples of additives, which may be natural or man-made materials, include, but are not limited to, plastic, rubber, sand, wood particles, sawdust, fibrous material, polyester fibrous material. One or more additives may be combined together in a casting material. The additives may or may not be biodegradable. In at least some embodiments, the casting material and additives are substantially non-toxic.

Examples of fabrics that may be employed include, but are not limited to, biodegradable fabrics, and non-biodegradable fabrics. The fabrics may include one or more natural and/or synthetic materials. Fabrics include fiberglass fabric, and polyester fabric. The fabrics may have a variety of desirable properties. Such properties may include, but are not limited to, one or more of fire-resistance, water-resistance, mold-resistance, fungus-resistance, heat-resistance, tear-resistance, to name a few examples. In one particular example, an impregnated fabric may take the form of orthopedic fiberglass or polyester or other fibrous casting tape, and resin.

The fabrics may take a variety of shapes and configurations. For example, the fabrics may be in sheet form, or in strips of a desired length and width. Alternatively, the fabrics can be in the form of tape, which may or may not be in a roll, of a desired width. As well, the thickness of the fabric can be selected as desired.

E. Example Methods for Use of Casting Materials and Fabrics

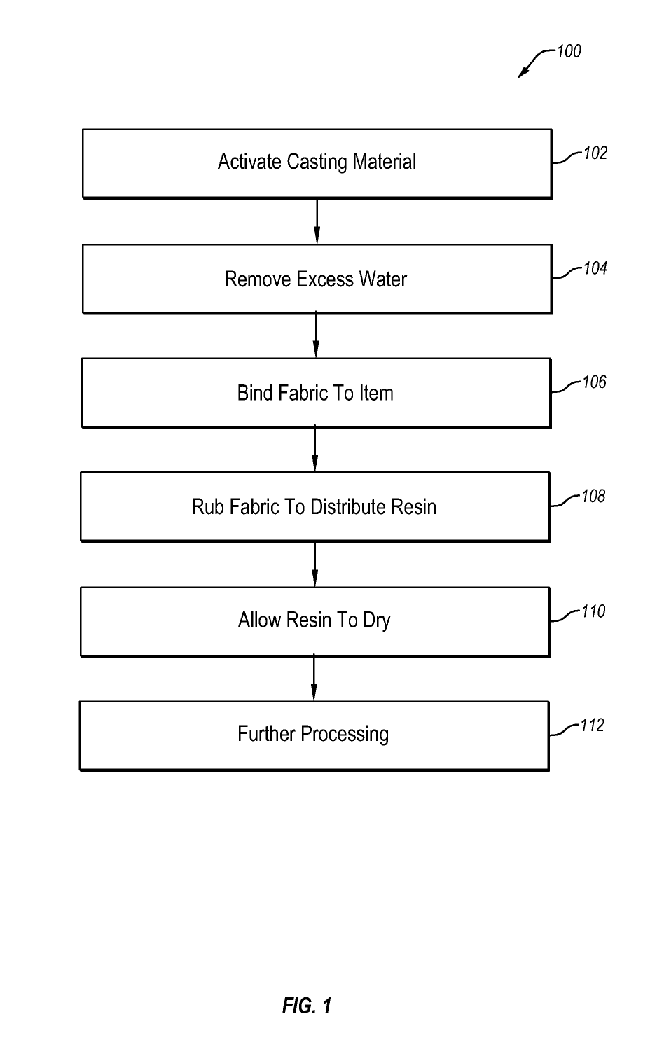

A variety of methods can be employed in the use of the casting materials and fabrics disclosed herein. The scope of the invention is not limited to any particular method, process or act employed in connection with the casting materials and fabrics. Below, some example methods and processes are discussed in detail, and with reference initially to FIG. 1.

In FIG. 1, an example process 100 is disclosed that may be used to repair an item, or to join two items. This example process begins with a fabric that is impregnated with, or otherwise includes, one or more casting materials. At 102, the casting material is activated. This may be accomplished, for example, by exposing the casting material to a curing agent such as light, water, heat, air, or a combination of any of the foregoing. In one particular example, the casting material may be immersed in, or otherwise exposed to, water that is in a temperature range of about 68 degrees F. to about 77 degrees F., although other temperatures and ranges can be employed. In this particular example, the casting material may be exposed to the water for about 10 to about 20 seconds, although other times and ranges can be employed.

In the instance where the curing agent is water, the process 100 advances to 104 where excess water is removed from the fabric, such as by compressing the wet fabric. In one particular example, the casting material will cure, or harden, between about 10 minutes and about 30 minutes after exposure to the curing agent, if the ambient temperature is about 70 degrees F. or higher. These times and temperatures may vary, depending upon the casting material(s) and/or curing agent(s) employed. In some applications, such as a leaking pipe for example, a relatively fast curing time may be desired. As well, where the ambient temperature is relatively cold, curing times may be correspondingly longer.

After the casting material has been activated, the fabric can then be wrapped, bound, or otherwise attached, 106, to the items that are to be joined together. Where the fabric is in the form of tape, the fabric may be wrapped around the two items so that each layer overlaps the previous layer by about 30 percent to about 40 percent of the width of the layer, although other overlap ranges can be used. In at least some instances, good results may be obtained when the fabric is wrapped relatively tightly. In one alternative embodiment, the process 106 is performed with respect to an opening or hole in an item such as a tube or pipe.

The overall length of the wrap can be such that the wrap extends a desired distance past either side of the joint formed by the two items to be joined together, or past the hole to be patched, as applicable. As noted elsewhere herein, the joint may be a point or area where an item has broken into two pieces, or begun to break, or the joint may simply be the area where two items, not previously attached to each other, interface with each other.

Once the wrap is in place, the casting material may be smoothed and more evenly distributed 108 by rubbing the casting material. This may be performed by hand or with a tool such as drywall knife for example. When the casting material has been satisfactorily distributed and smoothed, it can then be allowed to harden 110. In some instances, the casting material may harden in about 20 minutes if the ambient temperature is about 70 degrees F. or warmer.

Upon hardening, the casting material may form a relatively hard shell disposed about the joint between the two pieces to be joined together, or disposed over a hole to be patched. This hard shell can then be further processed 112 if desired, although such processing is not necessary. Such processing may include, but is not limited to, one or more of sanding, cutting, buffing, smoothing, shaping, forming, texturing, painting, sealing, priming,

F. Example Repair Using a Casting Material and Fabric

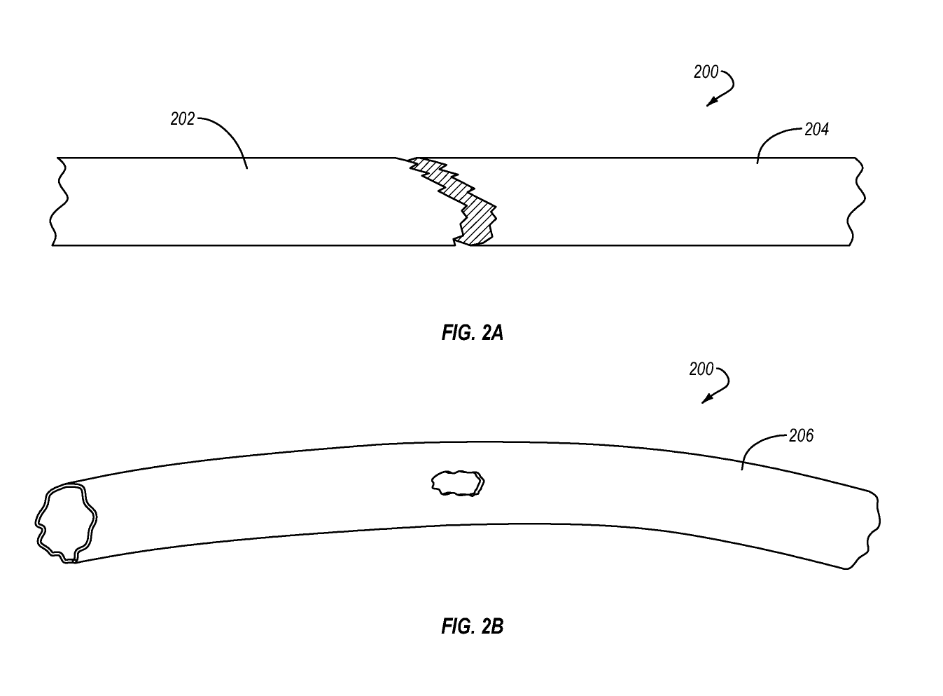

With attention now to FIGS. 2a-5, further details are provided concerning an item 200 repaired using the example method 100. In FIG. 2a, the item 200-comprises two or more portions 202 and 204 that are partially or completely broken apart from each other. Solely for the purposes of illustration, the item 200 may comprise a wooden tool handle that has split, fractured, or completely broken in two. As noted above, in an alternative embodiment, the method 100 may be used to join two items that had not previously been joined together. As indicated in FIG. 2b, the item 200 may alternatively comprise a portion 206 that has a hole which is desired to be repaired. Solely for the purposes of illustration, the item 200 that includes portion 206 may comprise a hose, pipe or tube.

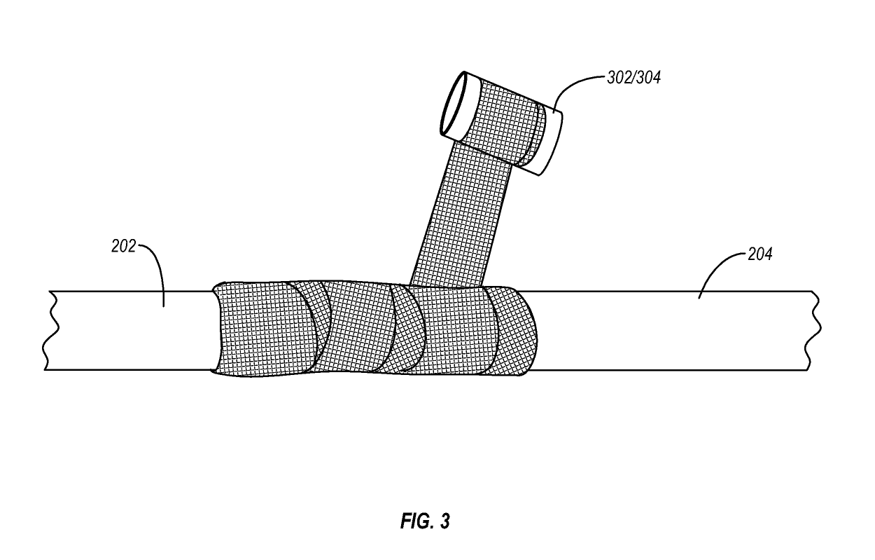

With attention now to FIG. 3, a casting material 302 and fabric 304 are indicated that take the form of a roll so that the casting material 302 and fabric 304 can be dispensed in a manner similar to that which would be used to dispense tape from a roll of tape. In this example, the fabric 304 is impregnated with the casting material 302 although, as noted elsewhere herein, the casting material 302 may be otherwise applied to the fabric 304. For example, the fabric 304 may be first placed in position on the item to be repaired, and the casting material 302 then applied to the fabric 304. However, impregnation of the fabric 304 with the casting material 302 prior to effecting the repair may produce better results in some instances as the impregnated fabric 304 may be less likely to slip out of position while the repair is being made.

As indicated in FIG. 3, which illustrates a partially wrapped item 200, the attachment, or reattachment, as applicable, of portions 202 and 204 may be effected by a spiral wrapping of the impregnated fabric 304. Aspects of the wrap such as the number of turns and the extent of overlap of adjacent turns can be varied as desired. In some instances, the turns may be simply wrapped one on top of the other, with little or no spiraling.

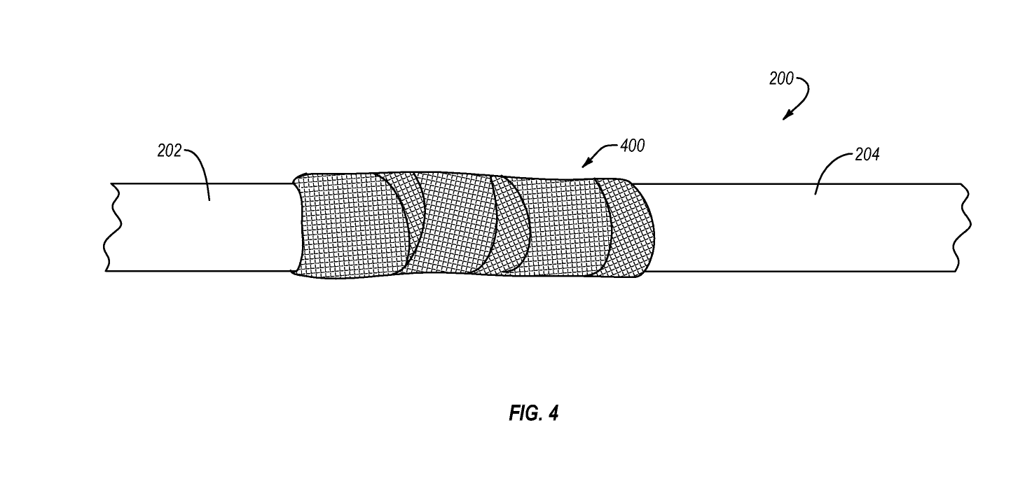

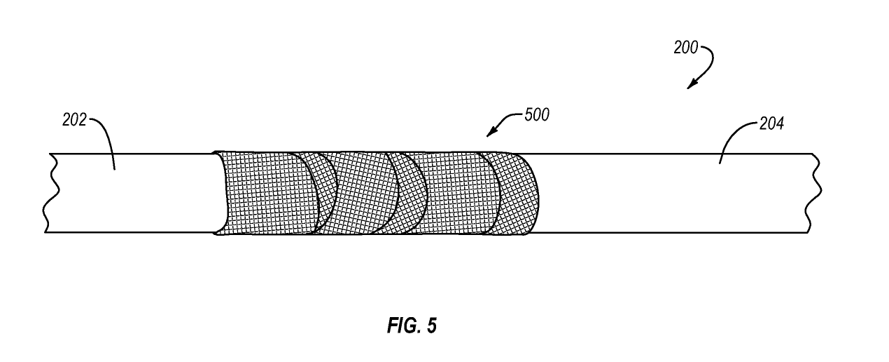

Turning now to FIG. 4, the item 200 is indicated with wrapping of the impregnated fabric 304 completed. As indicated in FIG. 4, when the casting material 302 has cured, a relatively hard shell 400 may be formed in the area where the items 202 and 204 are joined, or rejoined, together. With reference, finally, to FIG. 5, shell 400 has been processed to produce the processed shell 500 shown.

Although this disclosure has been described in terms of certain embodiments, other embodiments apparent to those of ordinary skill in the art are also within the scope of this disclosure. Accordingly, the scope of the disclosure is intended to be defined only by the claims which follow.

1. An attachment method for securing elements to one another, the attachment method comprising:
providing a first inanimate element; and
providing a second inanimate element;
providing a fabric, wherein the fabric includes an impregnated casting material;
positioning the first inanimate element and the second inanimate elements proximate each other in the position in which the first inanimate element and the second inanimate element will be secured to one another;
wrapping the fabric about a portion of the first inanimate element and a portion of the second inanimate element; and
curing the casting material.

2. The method as recited in claim 1, wherein the first inanimate element and second inanimate elements include respective portions of a fracture between the first and second inanimate elements.

3. The method as recited in claim 1, wherein one of the inanimate elements comprises at least one of:
wood;
metal;
glass;
plastic;
rubber;
composites;
fiberglass;
ceramic; or
concrete.

4. The method as recited in claim 1, wherein the casting material is cured by exposing the casting material to a curing agent.

5. The method as recited in claim 4, wherein the curing agent comprises at least one of:
water;
light;
heat; or
air.

6. The method as recited in claim 1, wherein the curing the casting material includes:
exposing the casting material to water; and
compressing the impregnated fabric to remove water.

7. The method as recited in claim 1, wherein the casting material is cured by exposing the casting material to water that has a temperature between 68 degrees F. and 77 degrees F.

8. The method as recited in claim 1, wherein wrapping the fabric about a portion of the first inanimate element and a portion of the second inanimate elements comprises:
providing a first layer of wrapping by wrapping the fabric, where each wrap in the first layer overlaps an adjacent wrap by a distance that is between about 30 percent and about 40 percent of a width of the fabric; and
repeating the preceding process until at least three layers of wrapping are present.

9. The method as recited in claim 1, wherein the fabric comprises at least one of:
a fiberglass fabric; or
a polyester fabric.

10. The method as recited in claim 1, wherein the casting material comprises a resin.

11. The method as recited in claim 1, further comprising an additive in the casting material.

12. An apparatus for securing elements to one another, the apparatus comprising:
a fabric; and
a casting material impregnated in the fabric;
wherein the fabric is configured to be wrapped around a portion of an inanimate object; and
wherein curing the casing material is configured to form a shell directly attached to the portion of the inanimate object.

13. The apparatus of claim 12, wherein the inanimate object comprises at least one of:
wood;
metal;
glass;
plastic;
rubber;
composites;
fiberglass;
ceramic; or
concrete.

14. The apparatus of claim 12, wherein the casting material comprises at least one of:
a synthetic resin; or
a natural resin.

15. The apparatus of claim 12, wherein the casting material is biodegradable.

16. The apparatus of claim 12, further comprising an additive disposed in the casting material.

17. A kit, comprising:
a roll of fabric;
a casting material impregnated into the fabric; and
one or more additives included in the casting material;
wherein the fabric is configured to be wrapped around a portion of an inanimate object; and
wherein curing the casing material is configured to form a shell about the portion of the inanimate object.

18. The kit as recited in claim 17, further comprising a pair of gloves.

19. The kit as recited in claim 17, wherein the additive comprises fibrous polyester.

20. The kit as recited in claim 17, wherein the casting material comprises at least one of:
a synthetic resin; or
a natural resin.

21. The kit as recited in claim 17, wherein the casting material and one or more additives are biodegradable.
